(19) United States
(12) Patent Application Publication
(10) Pub. No.: US 2026/0180416 A1
(43) Pub. Date: Jun. 25, 2026

(54) ROTATING MACHINE

(71) Applicants: HYUNDAI MOTOR COMPANY, Seoul (KR); KIA CORPORATION, Seoul (KR); CHANGWON NATIONAL UNIVERSITY INDUSTRY ACADEMY COOPERATION CORPS, Changwon-si (KR)

(72) Inventors: Byung Ho Min, Hwaseong-si (KR); Tae Gyu Lee, Hwaseong-si (KR); Hyung Kwan Jang, Hwaseong-si (KR); Ki Hwan Kim, Gimhae-si (KR); Seok Ho Kim, Gimhae-si (KR)

(73) Assignees: HYUNDAI MOTOR COMPANY, Seoul (KR); KIA CORPORATION, Seoul (KR); CHANGWON NATIONAL UNIVERSITY INDUSTRY ACADEMY COOPERATION CORPS, Changwon-si (KR)

(21) Appl. No.: 19/232,565

(22) Filed: Jun. 9, 2025

(30) Foreign Application Priority Data
Dec. 23, 2024 (KR) 10-2024-0193990

(51) Int. Cl. H02K 55/04

(52) U.S. Cl. CPC H02K 55/04

(57) ABSTRACT

A rotating machine includes a rotor. The rotor includes a reservoir provided with a coil block disposed on an outer peripheral surface of the reservoir, a rotating support portion coupled to the reservoir and including a bellows portion, a refrigerant pipe extending into an interior of the reservoir by penetrating through the rotating support portion, and a torque transmission portion coupled to the reservoir and the rotating support portion. The bellows portion is disposed inside the torque transmission portion.

### CROSS-REFERENCE TO RELATED APPLICATION(S)

This application claims the benefit of and priority to Korean Patent Application No. 10-2024-0193990 filed on Dec. 23, 2024 in the Korean Intellectual Property Office, the disclosure of which is incorporated herein by reference in its entirety.

### BACKGROUND

### Technical Field

The present disclosure relates to a superconducting rotating machine capable of cooling a rotor using a refrigerant.

### Description of Related Art

High Temperature Superconductor (HTS) rotating machines are high-temperature superconductor rotating machines that may be used in various fields such as electric motors, generators, wind turbines, and ship drives, because they have high power efficiency and may be miniaturized. Therefore, rotating machines may be used in various applications that require high output and miniaturization.

In the related art, coil blocks may be cooled by directly attaching a cryogenic refrigerator to the rotor or circulating a cryogenic refrigerant. However, the method of attaching a cryogenic refrigerator is structurally disadvantageous to cooling efficiency, and the circulating cooling method may cause difficulties in complex pipe design and installation.

Therefore, to prevent the above problems, a rotating machine that increases cooling efficiency and provides a simple cooling mechanism is required.

### SUMMARY

An aspect of the present disclosure is to prevent a refrigerant inside a rotor from leaking out when the rotor rotates, thereby maintaining a temperature of the rotor at an appropriate level and securing performance of a rotating machine.

Technical problems to be solved by the present disclosure are not limited to the above-mentioned technical problems, and other technical problems, which are not mentioned above, may be clearly understood from the following descriptions by those having ordinary skill in the art to which the present disclosure pertains.

The present disclosure has been made in an effort to solve the above-described problems associated with the prior art. The present disclosure provides a rotating machine. The rotating machine includes a rotor. The rotor includes a reservoir provided with a coil block disposed on an outer peripheral surface of the reservoir, a rotating support portion coupled to the reservoir and including a bellows portion, a refrigerant pipe extending into an interior of the reservoir by penetrating through the rotating support portion, and a torque transmission portion coupled to the reservoir and the rotating support portion. The bellows portion is disposed inside the torque transmission portion.

The torque transmission portion may include a body portion, a first disk portion disposed on one side of the body portion, and a second disk portion disposed on the other side of the body portion. The first disk portion may be coupled to the reservoir.

The reservoir may be provided with a reservoir flange disposed on one side of the reservoir, and the reservoir flange may be coupled to the first disk portion.

An inner peripheral surface of the body portion may be spaced apart from the bellows portion in a direction perpendicular to a rotational axis of the rotor.

The rotating support portion may include a first flange portion and a second flange portion. The bellows portion may be disposed between the first flange portion and the second flange portion, and the first flange portion may be coupled to the reservoir.

The rotating machine may further include a reservoir flange, the reservoir flange may be disposed on one side of the reservoir, and the reservoir flange may be coupled to the first flange portion.

The torque transmission portion may include a body portion, a first disk portion disposed on one side of the body portion, and a second disk portion disposed on the other side of the body portion. The second disk portion may be coupled to the second flange portion.

The rotating machine may further include a vacuum chamber in which the reservoir may be disposed.

The rotating support portion may include a first flange portion and a second flange portion. The bellows portion may be disposed between the first flange portion and the second flange portion, and the second flange portion may be coupled to the vacuum chamber.

One surface of the second flange portion may be coupled to the torque transmission portion, and the other surface of the second flange portion may be coupled to the vacuum chamber.

The bellows portion may be formed of stainless steel.

The torque transmission portion may be formed of glass fiber reinforced plastic.

The reservoir may include a reservoir body in which a refrigerant is disposed, and a reservoir flange coupled to one side of the reservoir body.

The torque transmission portion may include a body portion, and a first disk portion disposed on one side of the body portion and coupled to the reservoir flange, and a diameter of the first disk portion may be larger than a diameter of the reservoir body.

The above and other features of the disclosure are discussed below. The effects obtained by the present disclosure are not limited to the aforementioned effects, and other effects, which are not mentioned above, should be clearly understood by those having ordinary skill in the art from the following description.

### BRIEF DESCRIPTION OF DRAWINGS

The above and other aspects, features, and advantages of the present disclosure should be more clearly understood from the following description, taken in conjunction with the accompanying drawings, in which:

FIG. 1 is a cross-sectional perspective view illustrating a rotating machine according to an embodiment;

FIG. 2 is a cross-sectional view illustrating a rotating machine according to an embodiment;

FIG. 3 is a perspective view illustrating a reservoir according to an embodiment;

FIG. 4 is an exploded perspective view illustrating a reservoir according to an embodiment;

FIG. 5 is a cross-sectional view illustrating a reservoir according to an embodiment;

FIG. 6 is a perspective view of a rotating support portion according to an embodiment;

FIG. 7 is a cross-sectional view of a rotating support portion according to an embodiment;

FIG. 8 is a perspective view illustrating a torque transmission portion according to an embodiment; and

FIG. 9 is a cross-sectional view of a torque transmission portion according to an embodiment.

It should be understood that the appended drawings are not drawn to scale, presenting a somewhat simplified representation of various features illustrative of the basic principles of the disclosure. The specific design features of the present disclosure as disclosed herein, including, for example, specific dimensions, orientations, locations, and shapes are determined in part by the particular intended application and use environment.

In the figures, reference numbers refer to the same or equivalent parts of the present disclosure throughout the several figures of the drawings

### DETAILED DESCRIPTION

The present disclosure may have various modifications and various embodiments, and specific embodiments are illustrated in the drawings and described in detail. However, this is not intended to limit the present disclosure to specific embodiments, and it should be understood that all modifications, equivalents, and substitutes included in the spirit and technical scope of the present disclosure are included.

The terms such as first, second, and the like may be used to describe various components, but the components should not be limited by the terms. The terms are used only for the purpose of distinguishing one component from another. For example, without departing from the scope of the present disclosure, the first component may be named the second component, and similarly, the second component may also be named the first component. The term ‘and/or’ includes a combination of a plurality of related described items or any of a plurality of related described items.

The terms “-unit, -part, -portion,” and the like may be used to describe various components, but the components should not be limited by the terms. The above terms may refer to not only physically/visibly distinct configurations, but also to functions or configurations of corresponding parts even if the distinction/division is not clearly defined.

The terms used in this specification are used only to describe specific embodiments and are not intended to limit the present disclosure. The singular expression includes plural expressions unless the context clearly indicates otherwise. In this specification, the terms such as “include,” “have,” and the like should be understood to indicate the presence of features, numbers, steps, operations, components, parts, or combinations thereof described in the specification, but do not preclude the possibility of the presence or addition of one or more other features, numbers, steps, operations, components, parts, or combinations thereof.

Unless otherwise defined, all terms used herein, including technical or scientific terms, have the same meaning as generally understood by a person of ordinary skill in the art to which the present disclosure belongs. Terms that are defined in commonly used dictionaries should be interpreted as having a meaning consistent with the meaning they have in the context of the relevant technology, and are not interpreted in an ideal or overly formal sense unless explicitly defined in this specification.

In the description below, the terms “forward”, “backward”, “side”, “front”, “back”, “rear”, “upper”, “above”, “lower”, “below”, “left and right”, and the like used in relation to direction are defined based on the vehicle or body. In addition, the terms such as first, second, and the like may be used to describe various components, but these components are not limited in order, size, location, or importance by the terms of first, second, and the like, and are named only for the purpose of distinguishing one component from another.

Hereinafter, with reference to the attached drawings, an embodiment is described in more detail.

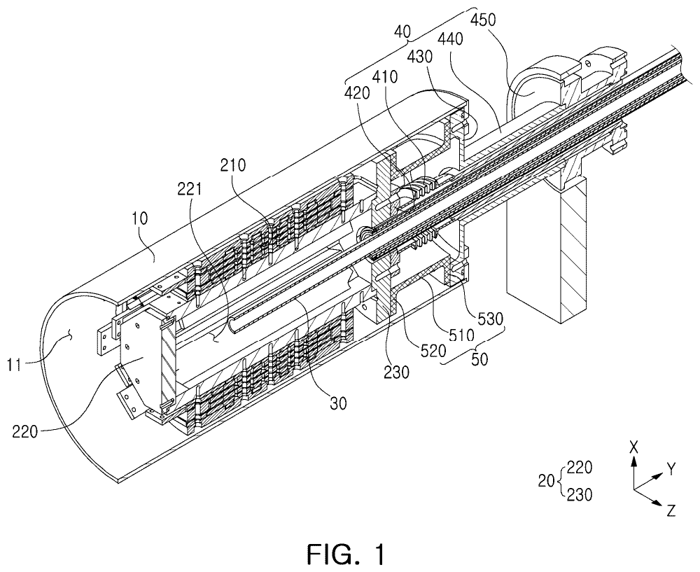

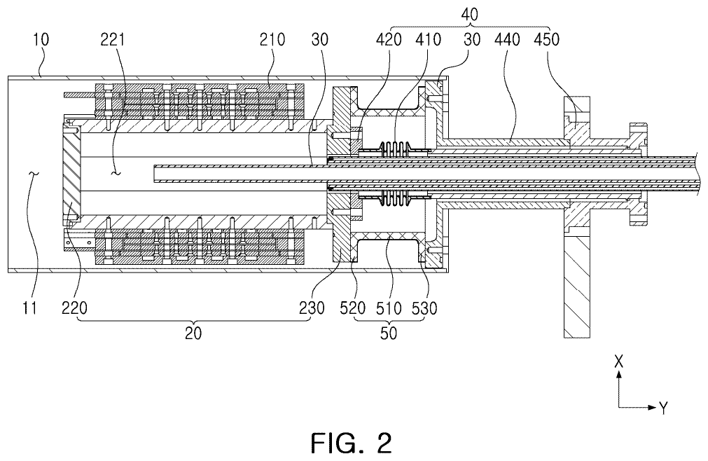

FIG. 1 is a cross-sectional perspective view illustrating a rotating machine according to an embodiment, and FIG. 2 is a cross-sectional view illustrating a rotating machine according to an embodiment.

Referring to FIG. 1 and FIG. 2, a rotating machine according to an embodiment may include a vacuum chamber 10, a reservoir 20, a refrigerant pipe 30, a rotating support portion 40, and a torque transmission portion 50.

The vacuum chamber 10 may have a hollow cylindrical structure. The vacuum chamber 10 may have a vacuum space 11. The vacuum space 11 may provide a high vacuum environment. The vacuum chamber 10 may be connected to a pump to maintain the vacuum space 11 in a vacuum state. The vacuum chamber 10 may have a cylindrical shape, but the shape of the vacuum chamber 10 is not limited thereto. The vacuum chamber 10 may have a first axis extending in a first direction as a rotation axis. The vacuum chamber 10 may block heat transfer between the reservoir 20 and the outside by maintaining the vacuum space 11 as a vacuum, thereby increasing the insulation.

The reservoir 20 may be located in the vacuum space 11. The reservoir 20 may be located inside the vacuum chamber 10. The reservoir 20 may be surrounded by the vacuum chamber 10. The reservoir 20 may be coupled to the vacuum chamber 10 by a rotating support portion 40. The reservoir 20 may rotate around the first axis together with the vacuum chamber 10.

The reservoir 20 may be cooled by receiving a refrigerant from the outside and transferring heat to the refrigerant. In an embodiment, the refrigerant may be, for example, hydrogen. However, the type of the refrigerant is not limited thereto. For example, the refrigerant may include helium, nitrogen, and the like.

The reservoir 20 may be a heat exchanger. The reservoir 20 may be coupled to a coil block 210. The coil block 210 may be provided in multiples. The multiple coil blocks 210 may be combined along the outer peripheral surface of the reservoir 20. Hereinafter, the multiple coil blocks 210 may be described as a single unit. When the reservoir 20 is cooled and the temperature of the coil block 210 is lowered, the coil block 210 may enter a superconducting state. The structure of the reservoir 20 is described below.

The refrigerant pipe 30 may supply refrigerant to the interior of the reservoir 20. One side of the refrigerant pipe 30 may be connected to a separate cooling system. The refrigerant pipe 30 may receive refrigerant from the cooling system and supply the refrigerant to the reservoir 20. The refrigerant pipe 30 may extend to the internal space 221 of the reservoir 20 by penetrating through one side of the vacuum chamber 10, the rotating support portion 40, and the reservoir 20. The refrigerant pipe 30 may be extended in the first direction.

The refrigerant pipe 30 may include a first refrigerant path and a second refrigerant path. For example, the refrigerant pipe may have a double structure. The first refrigerant path may supply refrigerant to the internal space 221 of the reservoir body 220. The second refrigerant path may discharge refrigerant from the internal space 221 of the reservoir body 220. The first refrigerant path and the second refrigerant path may be in contact with each other, but are not limited thereto.

The coil block 210 may be coupled to the reservoir 20. The coil block 210 may be coupled to the outer peripheral surface of the reservoir 20. The coil block 210 may be positioned between the reservoir 20 and the vacuum chamber 10. The coil block 210 may include various types of coils. For example, the coil may have a racetrack shape or a pancake shape, but the shape of the coil is not limited thereto. The coil block 210, which may be superconductive from the reservoir 20, may receive power from the outside and form a magnetic field. The magnetic field formed by the coil block 210 may be used to rotate a rotor including the reservoir 20 and the vacuum chamber 10, or to produce power for a generator. In an embodiment, the rotor may include a coil block 210, a reservoir 20, a vacuum chamber 10, a rotating support portion 40, and a torque transmission portion 50.

The stator (not illustrated) may be spaced outwardly from the outer side surface of the vacuum chamber 10. The stator may surround at least a portion of the vacuum chamber 10. The stator may surround the outer side surface of the vacuum chamber 10 along the rotational direction of the rotor. The stator may be fixed to a rotating housing (not illustrated) disposed on the outer side of the rotor. When power is applied to the coil block 210 to form a magnetic field, the rotor may rotate by the interaction between the rotor and the stator. Hereinafter, the stator is widely known, so a detailed description thereof is omitted.

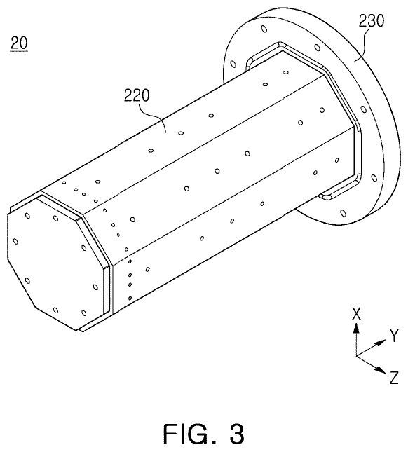

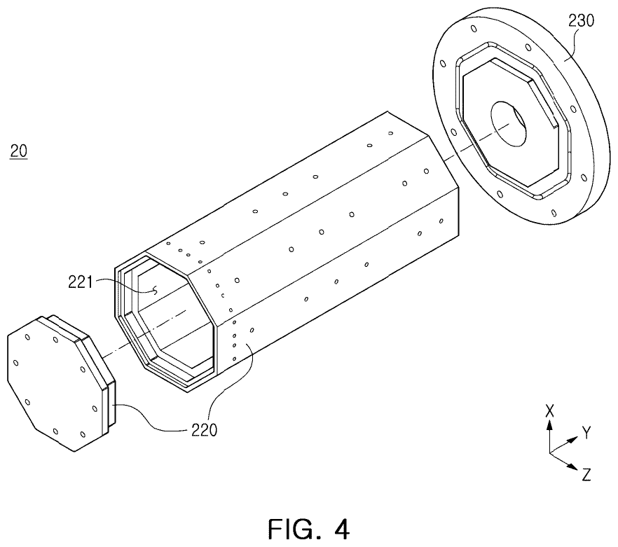

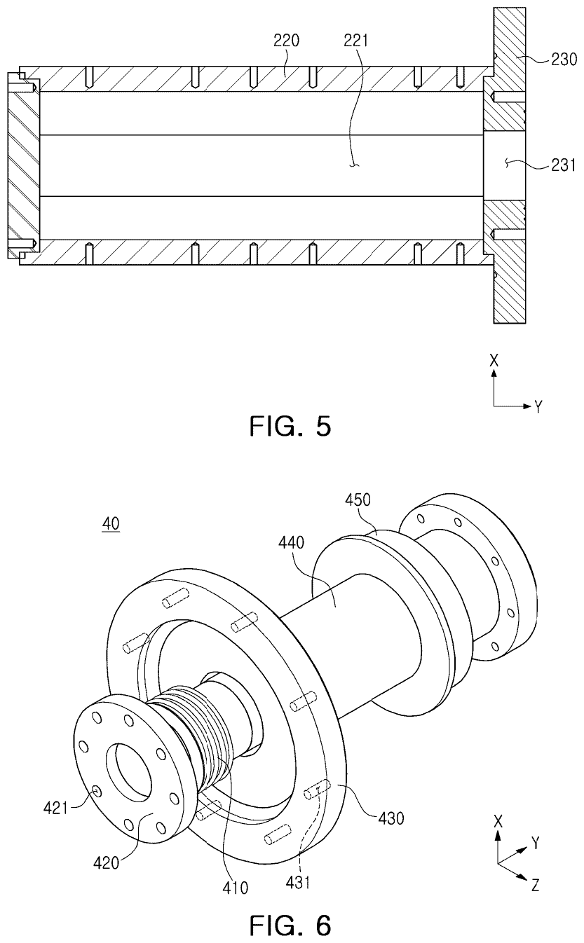

FIG. 3 is a perspective view illustrating a reservoir according to an embodiment, FIG. 4 is an exploded perspective view illustrating a reservoir according to an embodiment, and FIG. 5 is a cross-sectional view illustrating a reservoir according to an embodiment.

The reservoir 20 according to an embodiment may include a reservoir body 220 and a reservoir flange 230.

Referring to FIGS. 3 and 4, the reservoir body 220 may have a polygonal column shape. In an embodiment, the reservoir body 220 may have an octagonal column shape. The reservoir body 220 may have an internal space 221. At least a part of the refrigerant pipe 30 may be located in the internal space 221. The reservoir body 220 may store refrigerant in the internal space 221. The reservoir body 220 may extend in a first direction. Referring to FIG. 5, the reservoir body 220 may extend in the first direction by a first length.

The reservoir body 220 may be made of at least one of copper, aluminum, stainless steel, a nickel alloy, and a polymer composite material. However, the material of the reservoir body 220 is not limited thereto, and may further include other metal materials having high thermal conductivity.

Referring to FIG. 4, one side of the reservoir body 220 may be connected to a reservoir flange 230. The reservoir body 220 may be connected to other components of the rotor by the reservoir flange 230. More specifically, the reservoir flange 230 may connect the reservoir body 220 and the rotating support portion 40. The refrigerant pipe 30 may extend to the internal space 221 by penetrating through the reservoir flange 230. The reservoir flange 230 may have a through-hole 231 through which the refrigerant pipe 30 may pass. The diameter of the reservoir flange 230 may be larger than the diameter of the reservoir body 220. The material of the reservoir flange 230 may be the same as the material of the reservoir body 220, but is not limited thereto.

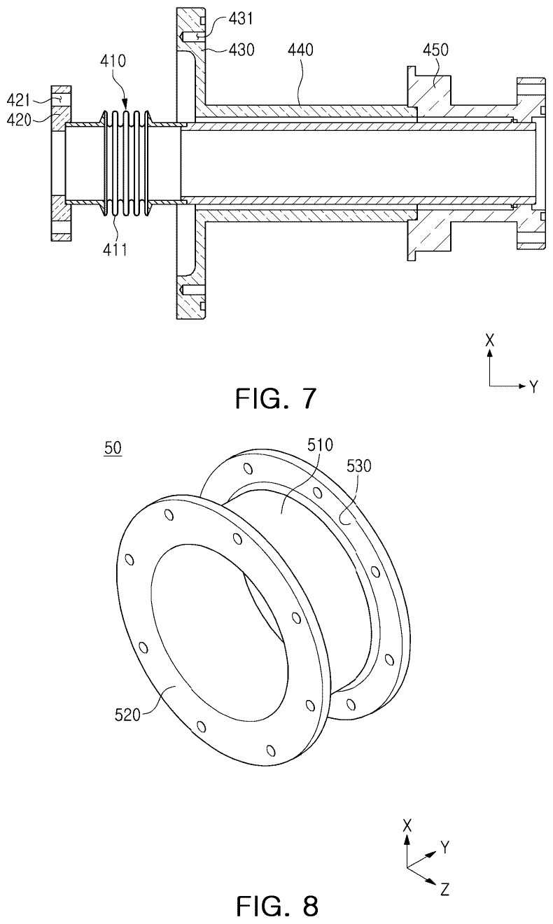

FIG. 6 is a perspective view of a rotating support portion according to an embodiment, and FIG. 7 is a cross-sectional view of a rotating support portion according to an embodiment. Referring to FIG. 6 and FIG. 7, the rotating support portion 40 may include a bellows portion 410, a first flange portion 420, a second flange portion 430, a body portion 440, and a bearing coupling portion 450.

The bellows portion 410 may connect the first flange portion 420 and the second flange portion 430. The first flange portion 420 and the second flange portion 430 may be spaced apart from each other in a first direction, which is a rotational axis direction of the rotor, with the bellows portion 410 interposed therebetween.

The bellows portion 410 may include a wrinkle portion 411 having a repeated wrinkle structure. The wrinkle portion 411 may absorb the torsional displacement that may occur due to the rotation of the rotating support portion 40. In addition, the bellows portion 410 may absorb the first direction displacement due to the temperature change.

The bellows portion 410 may be made or formed of a low-expansion alloy. For example, the bellows portion 410 may be made or formed of stainless steel. Since the bellows portion 410 is made or formed of a low-expansion alloy, the volume change may be small even when the temperature changes due to the refrigerant.

The first flange portion 420 may be disposed on one side of the bellows portion 410. The diameter of the first flange portion 420 may be larger than the diameter of the bellows portion 410. For example, the first flange portion 420 may have a structure that protrudes radially outwardly from the bellows portion 410. In addition, the first flange portion 420 may be structured to protrude along the outer peripheral surface of the bellows portion 410. A coupling hole 421 may be disposed in the first flange portion 420. A plurality of coupling holes 421 may be disposed therein. For example, a plurality of coupling holes 421 may be disposed to be spaced apart from each other along the circumferential direction of the first flange portion 420. A bolt may be fastened to the coupling hole 421 disposed in the first flange portion 420. The first flange portion 420 and the reservoir 20 may be coupled to each other through the bolt.

The second flange portion 430 may be disposed on the other side of the bellows portion 410. The diameter of the second flange portion 430 may be larger than the diameter of the first flange portion 420. For example, the second flange portion 430 may have a structure that protrudes radially outwardly from the bellows portion 410. In addition, the second flange portion 430 may have a structure that protrudes along the outer peripheral surface of the bellows portion 410. A coupling hole 431 may be disposed in the second flange portion 430. A plurality of coupling holes 431 may be disposed therein. For example, a plurality of coupling holes 431 may be disposed to be spaced apart from each other along the circumferential direction of the second flange portion 430. A bolt may be fastened to the coupling hole 431 disposed in the second flange portion 430. The second flange portion 430 and the vacuum chamber may be coupled to each other through the bolt.

The body portion 440 may have a cylindrical structure. The second flange portion 430 may be coupled to one side of the body portion 440, and a bearing coupling portion 450 may be coupled to the other side of the body portion 440. For example, the second flange portion 430 and the bearing coupling portion 450 may be spaced apart from each other with the body portion 440 interposed therebetween. A bearing may be coupled to the bearing coupling portion 450. For example, the rotation of the rotating support portion 40 may be supported through the bearing coupling portion 450.

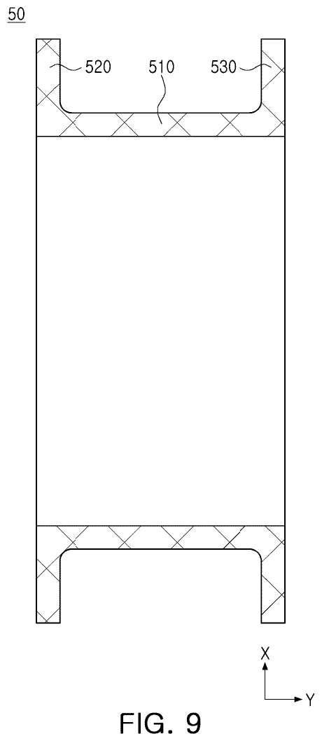

FIG. 8 is a perspective view illustrating a torque transmission portion according to an embodiment, and FIG. 9 is a cross-sectional view of the torque transmission portion according to an embodiment. Referring to FIGS. 8 and 9, the torque transmission portion 50 may include a body portion 510, a first disk portion 520, and a second disk portion 530. The first disk portion 520 may be disposed on one side of the body portion 510, and the second disk portion 530 may be disposed on the other side of the body portion 510. The torque transmission portion 50 may have a symmetrical structure with respect to a line perpendicular to the rotation axis. For example, the diameters of the first disk portion 520 and the second disk portion 530 may be the same. The material of the torque transmission portion 50 may be glass fiber reinforced plastic. Therefore, compared to the case where the torque transmission portion 50 is made or formed of metal, the mass of the torque transmission portion 50 may be reduced, and accordingly, the moment of inertia of the torque transmission portion 50 may be reduced.

Again, referring to FIG. 1 and FIG. 2, the joint structure of the rotating support portion 40 and the torque transmission portion 50 is examined.

The first flange portion 420 of the rotating support portion 40 is disposed to face the reservoir flange 230. The first flange portion 420 and the reservoir flange 230 may be joined by a bolt fastening method. The diameter of the first flange portion 420 may be smaller than the diameter of the reservoir flange 230. The second flange portion 430 of the rotating support portion 40 may be joined with the vacuum chamber 10 and the torque transmission portion 50. Specifically, one side of the second flange portion 430 may be coupled to the vacuum chamber 10, and the other side of the second flange portion 430 may be coupled to the torque transmission portion 50. The second flange portion 430 and the vacuum chamber 10 may be coupled in a bolt-fastening manner. A bearing may be coupled to the bearing coupling portion 450 of the rotating support portion 40. The rotation of the rotor including the rotating support portion 40 may be supported through the bearing.

The torque transmission portion 50 may be disposed between the reservoir flange 230 and the second flange portion 430 of the rotating support portion 40. The reservoir flange 230 and the second flange portion 430 may be connected through the torque transmission portion 50. Specifically, the first disk portion 520 of the torque transmission portion 50 may be coupled to the reservoir flange 230, and the second disk portion 530 may be coupled to the second flange portion 430. The diameter of the first disk portion 520 may be approximately the same as the diameter of the reservoir flange 230. The inner diameter of the torque transmission portion 50 may be larger than the diameter of the first flange portion 420. Therefore, the first flange portion 420 and the bellows portion 410 may be disposed on the inner side of the torque transmission portion 50.

Again, referring to FIG. 1, the operation and effect of the rotor according to the present disclosure is examined. When current flows through the coil block 210, a rotational force is applied to the reservoir 20 by electromagnetic interaction with the stator.

The reservoir flange 230 is coupled to the rotating support portion 40 and the torque transmission portion 50, and the rotating support portion 40 is coupled to the vacuum chamber 10, so that the reservoir 20, the rotating support portion 40, the torque transmission portion 50, and the vacuum chamber 10 may become a rotating rotor.

The diameter of the reservoir flange 230 is larger than the diameter of the reservoir body 220. The first flange portion 420 is coupled to the reservoir flange 230, and the first disk portion 520 is coupled to the reservoir flange 230 at a radially outer side than the first flange portion 420. In other words, the location of the coupling between the first flange 420 and the reservoir flange 230 is interior to the location of the coupling between the first disk portion 520 and the reservoir flange 230.

The rotational force acting on the reservoir 20 may be transmitted to the rotating support portion 40 through the torque transmission portion 50 and the first flange portion 420. Rotation of the reservoir 20 may cause a displacement due to torsion between the reservoir flange 230 and the first flange portion 420. Since the first flange portion 420 is connected to the bellows portion 410, the displacement due to torsion may be offset. In addition, since the rotational force applied to the reservoir 20 is also transmitted to the torque transmission portion 50, the rotational force transmitted to the first flange portion 420 may be reduced, thereby significantly reducing the torsional displacement between the reservoir flange 230 and the first flange portion 420. Accordingly, a defect between the reservoir flange 230 and the rotating support portion 40 and a leakage of refrigerant may be prevented.

As set forth above, in a rotating machine according to an embodiment, an appropriate temperature of a rotor may be maintained by preventing leakage of refrigerant introduced into the rotor through a defective part of the rotor. Accordingly, stable performance of the rotating machine may be secured.

While embodiments have been illustrated and described above, it should be apparent to those having ordinary skill in the art that modifications and variations could be made without departing from the scope of the present disclosure as defined by the appended claims.

What is claimed is:

1. A rotating machine comprising:
a rotor,
wherein the rotor includes:
a reservoir provided with a coil block disposed on an outer peripheral surface of the reservoir;
a rotating support portion coupled to the reservoir and including a bellows portion;
a refrigerant pipe extending into an interior of the reservoir by penetrating through the rotating support portion; and
a torque transmission portion coupled to the reservoir and the rotating support portion,
wherein the bellows portion is disposed inside the torque transmission portion.

2. The rotating machine of claim 1, wherein the torque transmission portion includes:
a body portion;
a first disk portion disposed on one side of the body portion; and
a second disk portion disposed on the other side of the body portion,
wherein the first disk portion is coupled to the reservoir.

3. The rotating machine of claim 2, wherein a reservoir flange is disposed on one side of the reservoir, and
wherein the reservoir flange is coupled to the first disk portion.

4. The rotating machine of claim 2, wherein an inner peripheral surface of the body portion is spaced apart from the bellows portion in a direction perpendicular to a rotational axis of the rotor.

5. The rotating machine of claim 1, wherein the rotating support portion includes a first flange portion and a second flange portion,
wherein the bellows portion is disposed between the first flange portion and the second flange portion, and
wherein the first flange portion is coupled to the reservoir.

6. The rotating machine of claim 5, further comprising a reservoir flange,
wherein the reservoir flange is disposed on one side of the reservoir, and
the reservoir flange is coupled to the first flange portion.

7. The rotating machine of claim 5, wherein the torque transmission portion includes:
a body portion;
a first disk portion disposed on one side of the body portion; and
a second disk portion disposed on the other side of the body portion,
wherein the second disk portion is coupled to the second flange portion.

8. The rotating machine of claim 1, further comprising a vacuum chamber in which the reservoir is disposed.

9. The rotating machine of claim 8, wherein the rotating support portion includes a first flange portion and a second flange portion,
wherein the bellows portion is disposed between the first flange portion and the second flange portion, and
wherein the second flange portion is coupled to the vacuum chamber.

10. The rotating machine of claim 9, wherein one surface of the second flange portion is coupled to the torque transmission portion, and
the other surface of the second flange portion is coupled to the vacuum chamber.

11. The rotating machine of claim 1, wherein the bellows portion is formed of stainless steel.

12. The rotating machine of claim 1, wherein the torque transmission portion is formed of glass fiber reinforced plastic.

13. The rotating machine of claim 1, wherein the reservoir includes:
a reservoir body in which a refrigerant is disposed; and
a reservoir flange coupled to one side of the reservoir body.

14. The rotating machine of claim 13, wherein the torque transmission portion includes:
a body portion; and
a first disk portion disposed on one side of the body portion and coupled to the reservoir flange,
wherein a diameter of the first disk portion is larger than a diameter of the reservoir body.

15. A rotating machine comprising:
a rotor,
wherein the rotor includes:
a vacuum chamber;
a reservoir disposed in the vacuum chamber;
a coil block disposed on an outer peripheral surface of the reservoir;
a rotating support portion coupled to the reservoir; and
a torque transmission portion coupled to the reservoir and the rotating support portion,
wherein the coil block is disposed between the reservoir and the vacuum chamber.

16. The rotating machine of claim 15, further comprising a refrigerant pipe extending into an internal space of the reservoir by penetrating through one side of the vacuum chamber.

17. The rotating machine of claim 16, wherein the refrigerant pipe includes:
a first refrigerant path configured to supply refrigerant to the internal space of the reservoir; and
a second refrigerant path configured to discharge the refrigerant from the internal space of the reservoir.

18. The rotating machine of claim 15, wherein the coil block is configured to enter a superconducting state and is comprised of a plurality of coil blocks combined along the outer peripheral surface of the reservoir.

19. The rotating machine of claim 15, wherein the coil block is configured to form a magnetic field when power is applied to the coil block, such that the magnetic field formed by the coil block rotates the reservoir and the vacuum chamber.
